(19) United States
(12) Patent Application Publication
(10) Pub. No.: US 2005/0018315 A1
(43) Pub. Date: Jan. 27, 2005

(54) Method of manufacturing hybrid aspherical lens

(75) Inventors: Seok-il Yoon, Daejeon Metropolitan City (KR); Gyu-hwan Hwang, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 10/832,479

(22) Filed: Apr. 27, 2004

(30) Foreign Application Priority Data
May 1, 2003 (KR) 2003-27998

(51) Int. Cl. G02B 3/00; G02B 9/00; G02B 3/02; G02B 13/18

(52) U.S. Cl. 359/708

(57) ABSTRACT

Provided is a method of manufacturing a hybrid aspherical lens. The method includes processing a spherical lens, depositing an aspherical lens material layer on the spherical lens, and pressing a compression mold with an aspherical surface onto the aspherical lens material layer to form the hybrid aspherical lens over the spherical lens. Thus, a hybrid aspherical lens without shaping errors can be manufactured using a simple process.

### BACKGROUND OF THE INVENTION

This application claims the priority of Korean Patent Application No. 2003-27998, filed on May 1, 2003, in the Korean Intellectual Property Office, the disclosure of which is incorporated herein in its entirety by reference.

1. Field of the Invention

A method consistent with the present invention relates to a method of manufacturing a hybrid aspherical lens.

2. Description of the Related Art

A method of manufacturing a hybrid aspherical lens using an ultraviolet (UV) bonding process is disclosed in Japanese Patent Publication No. 9-211280. FIG. 1 is a cross-sectional view of the hybrid aspherical lens manufactured using the UV bonding process disclosed in Japanese Patent Publication No. 9-211280.

Referring to FIG. 1, a hybrid lens 1 is composed of an aspherical lens 2 and a spherical lens 8. The aspherical lens 2 has a first optical surface 3 that acts as an incident surface and a second optical surface 4 that acts as an exit surface. The spherical lens 8 has a third optical surface 9 that acts as an incident surface and a fourth optical surface 10 that acts as an exit surface. Here, the third optical surface 9 is spherical and faces the second optical surface 4. The aspherical lens 2 and the spherical lens 8 are made of optical materials, such as plastic or glass. The aspherical lens 2 and the spherical lens 8 are manufactured by being integrally molded because they have no rib portions. The aspherical lens 2 and the spherical lens 8 are bonded by injecting a UV curing adhesive to the outer surface of the third optical surface 9 of the spherical lens 8 and applying ultraviolet rays. Here, reference numeral 5 denotes a bonding surface between the aspherical lens 2 and the spherical lens 8.

The conventional method of manufacturing a hybrid aspherical lens uses the UV curing adhesive to bond the aspherical lens with the spherical lens, thereby leading to a complicated production process and errors in shaping the aspherical surface.

### SUMMARY OF THE INVENTION

A method consistent with the present invention provides a simpler way to manufacture a hybrid aspherical lens without shaping errors.

According to an aspect of the present invention, there is provided a method of manufacturing a hybrid aspherical lens, comprising: processing a spherical lens; depositing an aspherical lens material layer on the spherical lens; and pressing a compression mold having an aspherical surface onto the aspherical lens material layer to form an aspherical lens over the spherical lens.

According to another aspect of the present invention, there is provided a method of manufacturing a hybrid aspherical lens, comprising: (a) forming a spherical lens; (b) inserting the spherical lens into a mold with an aspherical surface and injecting a molten aspherical lens material onto the outer periphery of the spherical lens; and (c) solidifying the aspherical lens material over the spherical lens to form an aspherical lens.

The spherical lens may be made of glass and the aspherical lens may be made of a polymer resin with adhesive properties.

The polymer resin may have a refractive index ranging from 1.45 to 1.68, and the spherical lens may have a different refractive index from that of the aspherical lens.

The aspherical lens may be formed on an incident surface and/or an exit surface of the spherical lens.

The aspherical lens may be a power lens or an anastigmatic lens.

### BRIEF DESCRIPTION OF THE DRAWINGS

The above and other features and advantages of the present invention will be readily apparent by describing, in detail, exemplary embodiments thereof with reference to the accompanying drawings, in which:

FIG. 1 is a cross-sectional view of a hybrid lens disclosed in Japanese Patent Publication No. 9-211280;

FIGS. 2A through 2C are diagrams illustrating a process of manufacturing a hybrid aspherical lens according to a first embodiment of the present invention; and

FIGS. 3A through 3C are diagrams illustrating a process of manufacturing a hybrid aspherical lens according to a second embodiment of the present invention.

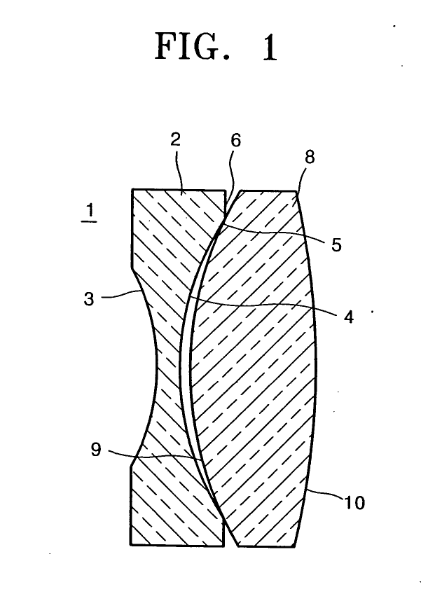

### DETAILED DESCRIPTION OF ILLUSTRATIVE, NON-LIMITING EMBODIMENTS OF THE INVENTION

A method consistent with the present invention will now be described more fully with reference to the accompanying drawings, in which illustraive, non-limiting embodiments of the invention are shown.

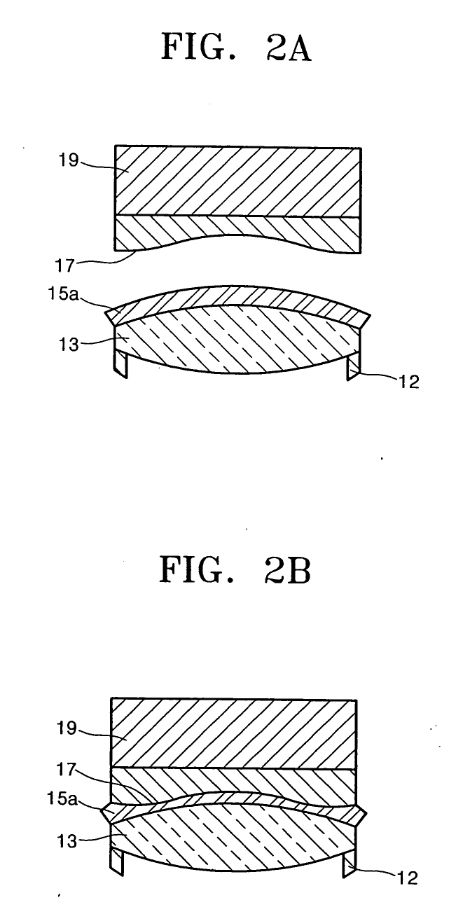

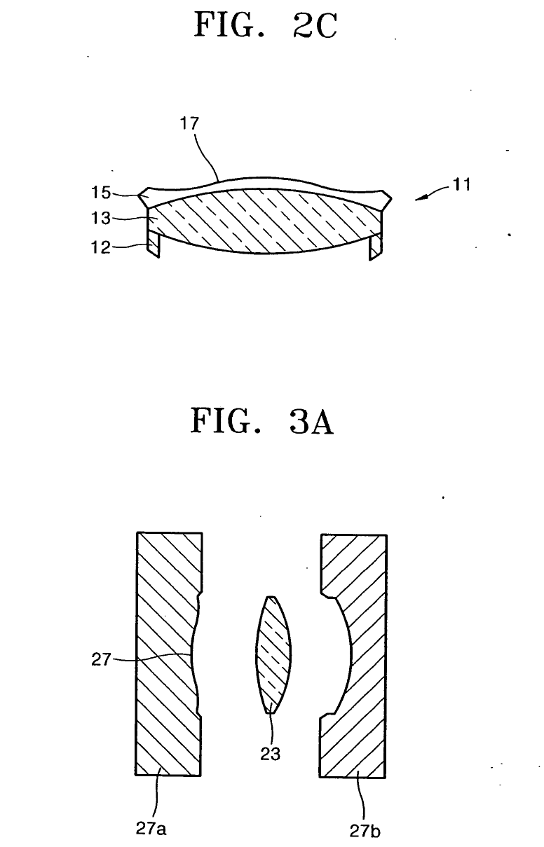

FIGS. 2A through 2C are diagrams illustrating a process of manufacturing a hybrid aspherical lens according to a first embodiment of the present invention.

As shown in FIG. 2A, a processed spherical lens 13 is disposed on a support 12. A polymer layer 15a is deposited on the spherical lens 13. A compression mold 19 having an aspherical surface formed thereon is disposed on the polymer layer 15a. As shown in FIG. 2B, the compression mold 19 is pressed onto the surface of the polymer layer 15a, such that the polymer layer 15a conforms to the shape of the aspherical surface 17 formed on the compression mold 19. Then, the polymer layer 15a is cured. Through the above procedure, a hybrid lens 11 as shown in FIG. 2C is formed in which an aspherical lens 15 is formed on the spherical lens 13.

Although the aspherical lens 15 is formed on only one side of the spherical lens in the process described above with reference to FIGS. 2A through 2C, the aspherical lens 15 may be formed on both sides (incident surface and exit surface) of the spherical lens 13 in a similar manner. Further, the polymer layer 15a may be formed in multiple layers so as to form a plurality of aspherical lenses on the spherical lens 13.

The hybrid aspherical lens manufacturing method using the compression molding technique according to the first embodiment can bond the aspherical lens 15 with the spherical lens 13 without an additional adhesive, and accordingly, the hybrid aspherical lens can be manufactured at a low cost. Furthermore, when the spherical lens 13 is made of a material having a different optical structure from that of the aspherical lens 15, the hybrid lens can function as an anastigmatic lens or a power lens.

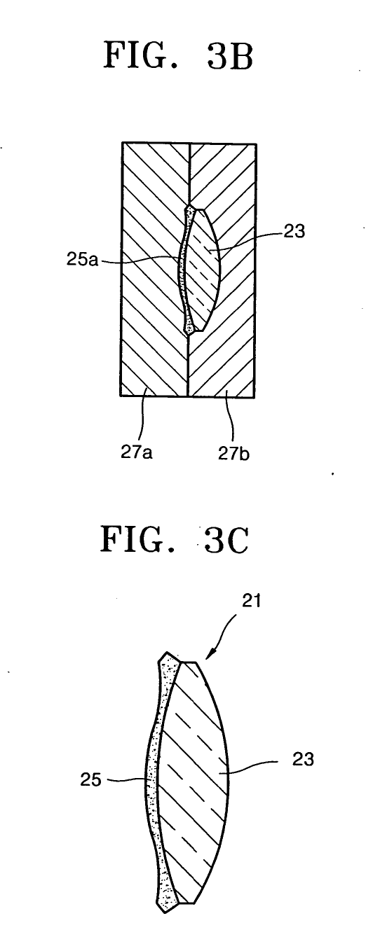

FIGS. 3A through 3C are diagrams illustrating a process of manufacturing a hybrid aspherical lens according to a second embodiment of the present invention.

FIG. 3A shows a processed spherical lens 23, a first mold 27a having an aspherical surface 27 formed on the inner surface thereof and a second mold 27b. The spherical lens 23 is disposed on and fixed to the inner surface of second mold 27b. Thereafter, as shown in FIG. 3B, a molten polymer resin 25a is injected into a space between the spherical lens 23 and the first mold 27a and then is solidified. The solidification is carried out using the natural adhesive properties of the polymer resin 25a instead of an ultraviolet (UV) curing process or a thermal curing process.

The polymer resin 25a with adhesive properties is curable at a normal temperature, however, the curing time can be shortened by applying ultraviolet rays or heat to the polymer resin. The first mold 27a contacting the polymer resin 25a is made of an antiadhesive material. Therefore, the polymer resin 25a does not adhere to the first mold 27a but can adhere to the spherical lens 23, thus, making it possible to manufacture a hybrid aspherical lens 21. The polymer resin 25a may be an acrylic resin with a refractive index ranging from 1.45 to 1.68. Fused silica can be used as the antiadheisve material of the first mold 27a.

As shown in FIG. 3C, after the first and second molds 27a and 27b are removed, the spherical lens 23 and an aspherical lens 25 have been bonded to form the hybrid aspherical lens 21. The aspherical lens 25 may be formed on one or both sides of the spherical lens 23. If the asperical lens 25 is formed on both sides of the spherical lens 23, then both the first and second molds 27a and 27b have an aspherical surface formed on their respective inner surfaces thereof.

In the hybrid aspherical lens manufacturing method according to the first and second embodiments of the present invention, the polymer resin may be deposited in multiple layers on the spherical lens 23, and at least one layer of the aspherical lens 25 may be formed at both sides of the spherical lens 23 as well.

A lens surface z of the aspherical lens 25 satisfies Equation 1, wherein c is a surface curvature (inverse function of radius), ρ is a radial coordinate on an optical surface, k is a conic constant, and αaᵢ is a polynomial coefficient that defines deviation from a spherical surface.

$$z = \frac{c {ρ}^{2}}{1 + \sqrt{1 - ( 1 + k ) {c}^{2} {ρ}^{2}}} + {\sum }_{i = 2}^{7} {α}_{i} {ρ}_{i}^{2} \qquad [ Equation 1 ]$$

Table 1 shows data, i.e., radius and thickness values, of hybrid aspherical lenses manufactured by the method according to the preferred embodiments of the present invention.

TABLE 1

| No. | Radius | Thickness |
|---|---|---|
| 1 | 57.63879 | 10.000000 |
| 2 | 64.01250 | 14.455710 |
| 3 | −186.57078 | 6.722585 |
| 4 | −342.19600 | 7.300000 |
| 5 | −75.09904 | 20.972564 |
| 6 | −35.80509 | 4.000000 |

Table 2 presents aspherical coefficients of the lenses shown in Table 1 (in current optical scheme design, k=0)

TABLE 2

| | 1 | 2 | 3 | 4 | 5 | 6 |
|---|---|---|---|---|---|---|
| a₁ | −0.18077 × 10⁻⁵ | −1.34298 × 10⁻⁵ | −0.427016 × 10⁻⁶ | −0.281225 × 10⁻⁵ | −0.871255 × 10⁻⁶ | −0.753692 × 10⁻⁶ |
| a₂ | −0.554128 × 10⁻⁹ | −0.42274 × 10⁻⁹ | −0.268804 × 10⁻⁸ | −0.411329 × 10⁻⁸ | −0.115339 × 10⁻⁷ | −0.162173 × 10⁻⁷ |
| a₃ | −0.10034 × 10⁻″ | −0.116092 × 10⁻″ | −0.852380 × 10⁻″ | −0.112696 × 10¹⁰ | −0.311058 × 10⁻¹⁰ | −0.389878 × 10⁻¹⁰ |

The hybrid aspherical lens manufacturing method according to the first and second embodiments of the present invention can minimize shaping errors of the aspherical surface, which often occur in conventional injection-type aspherical lenses, and can reduce manufacturing errors. Thus, a high quality hybrid aspherical lens can be produced. In addition, a method consistent with the present invention can manufacture the hybrid structure composed of the spherical lens and the aspherical lens without a separate bonding process, and accordingly, mass production can be realized at a low cost.

As described above, the hybrid aspherical lens manufacturing method consistent with the present invention has an advantage of a simple manufacturing process where a hybrid aspherical lens is formed without a separate bonding process. Therefore, the hybrid aspherical lens has a precise aspherical surface without errors in shaping and contamination due to an additional adhesive.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of manufacturing a hybrid aspherical lens, comprising:
processing a spherical lens;
depositing an aspherical lens material layer on the spherical lens; and
pressing a compression mold having an aspherical surface onto the aspherical lens material layer to form the hybrid aspherical lens over the spherical lens.

2. The method of claim 1, wherein the spherical lens is made of glass.

3. The method of claim 1, wherein the aspherical lens material layer is made of a polymer resin with adhesive properties.

4. The method of claim 3, wherein the polymer resin has a refractive index ranging from 1.45 to 1.68.

5. The method of claim 1, wherein the spherical lens has a different refractive index from that of the hybrid aspherical lens.

6. The method of claim 1, wherein the hybrid aspherical lens is formed on an incident surface and an exit surface of the spherical lens.

7. The method of claim 1, wherein the hybrid aspherical lens is a power lens.

8. The method of claim 1, wherein the hybrid aspherical lens is an anastigmatic lens.

9. A method of manufacturing a hybrid aspherical lens, comprising:
(a) forming a spherical lens;
(b) inserting the spherical lens into a mold with an aspherical surface and injecting a molten aspherical lens material onto the outer periphery of the spherical lens; and
(c) solidifying the aspherical lens material over the spherical lens to form the hybrid aspherical lens.

10. The method of claim 9, wherein the spherical lens is made of glass.

11. The method of claim 9, wherein the hybrid aspherical lens is made of a polymer resin with adhesive properties.

12. The method of claim 11, wherein the polymer resin has a refractive index ranging from 1.45 to 1.68.

13. The method of claim 9, wherein the spherical lens has a different refractive index from that of the hybrid aspherical lens.

14. The method of claim 9, wherein in step (b), the hybrid aspherical lens is formed on an incident surface and an exit surface of the spherical lens.

15. The method of claim 9, wherein the hybrid aspherical lens is a power lens.

16. The method of claim 9, wherein the hybrid aspherical lens is an anastigmatic lens.

17. The method of claim 9, wherein in step (c), the hybrid aspherical lens material is solidified using an ultraviolet curing process or a thermal curing process.
